(19) United States
(12) Patent Application Publication
(10) Pub. No.: US 2018/0036868 A1
(43) Pub. Date: Feb. 8, 2018

(54) CLAMPING MECHANISM FOR AN ADJUSTABLE LENGTH TOOL

(71) Applicant: Fiskars Brands, Inc., Madison, WI (US)

(72) Inventors: Jake Maki, Chassell, WI (US); James Meiller, Fitchburg, WI (US); Jay Munroe, McFarland, WI (US)

(73) Assignee: Fiskars Brands, Inc., Madison, WI (US)

(21) Appl. No.: 15/229,696

(22) Filed: Aug. 5, 2016

(51) Int. Cl. B25B 5/14; B25G 1/04; A01G 3/025

(52) U.S. Cl. CPC B25B 5/147; A01G 3/0255; B25G 1/04

(57) ABSTRACT

A clamping mechanism for an adjustable length tool is provided herein. The clamping mechanism includes a body having a top end, a bottom end opposite the top end, and a top portion proximate the top end; and, a lever rotatably coupled to the body between an unlocked position and a locked position, wherein the lever engages with the body during a movement of the lever to the locked position to cause a deformation of the top portion of the body. According to one embodiment, deformation of the top portion of the body is structured to prevent relative movement between an inner pole of the adjustable length tool and the top portion of the body.

### FIELD

The present disclosure relates to hand operated tools. More particularly, the present disclosure relates to telescoping or adjustable length hand operated tools.

### BACKGROUND

This section is intended to provide a background or context to the disclosure recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Adjustable length tools are useful in a variety of applications, such as reaching elements at differing heights relative to a ground surface. An example of an adjustable length tool is a tree pruner. Tree pruners typically utilize a movable pole that enables the pruner portion of the tree pruner to reach elements of a tree at varying heights relative to a ground surface. In this regard, actuation of the movable pole enables a user to reach branches of a tree that the user would otherwise be unable to reach. However, current tree pruners utilize awkward or hard-to-operate control mechanisms that control the movable pole. Typically, a user must hold a user engagement pole of the tree pruner and complete multiple twists or untwists of a locking mechanism (e.g., a wing nut) to enable relative movement between the movable pole and the user engagement pole. The act of twisting/untwisting can be a difficult and cumbersome due to, for example, the requirement of the user to also move the movable pole to a desired extension distance from the user engagement pole. Further, this action can be difficult for people with various medical conditions (e.g., arthritis) or relatively-low grip strength.

### SUMMARY

One embodiment relates to a clamping mechanism for an adjustable length tool. The clamping mechanism includes a body having a top end, a bottom end opposite the top end, and a top portion proximate the top end; and, a lever rotatably coupled to the body between an unlocked position and a locked position, wherein the lever engages with the body during a movement of the lever to the locked position to cause a deformation of the top portion of the body. According to one embodiment, deformation of the top portion of the body is structured to prevent relative movement between an inner pole of the adjustable length tool and the top portion of the body.

Another embodiment relates to a tree pruner. The tree pruner includes an outer pole; an inner pole disposed at least partly within the outer pole, the inner pole movable relative to the outer pole; and, a clamping mechanism coupled to the outer pole, the clamping mechanism structured to selectively engage with the inner pole to prevent relative movement between the inner and outer poles. According to one embodiment, the clamping mechanism includes: a body having a top portion, wherein the body is coupled to the outer pole; and, a lever movably coupled to the top portion between an unlocked position and a locked position, wherein the lever includes a cam surface that engages with the body during movement of the lever to the locked position to cause deformation of the top portion of the body to engage with the inner pole and prevent relative movement between the inner and outer poles in the locked position.

Still another embodiment relates to a tool. The tool includes a pole; a body at least partially surrounding the pole; and, a lever rotatably coupled to the body between a locked position and an unlocked position, the lever including a cam surface, wherein the cam surface engages with the body to deform the body in the locked position to substantially prevent relative movement between the pole and the body, and wherein a transition of the lever into the locked position creates an audible noise.

### BRIEF DESCRIPTION OF THE DRAWINGS

FIG. 1 is a perspective view of an adjustable length tool, shown as a tree pruner, with a clamping mechanism, according to an exemplary embodiment.

FIG. 2 is a front view of the tree pruner of FIG. 1, according to an exemplary embodiment.

FIG. 3 is a right side view of the tree pruner of FIG. 1, according to an exemplary embodiment.

FIG. 4 is a rear view of the tree pruner of FIG. 1, according to an exemplary embodiment.

FIG. 5 is a left side view of the tree pruner of FIG. 1, according to an exemplary embodiment.

FIG. 6 is a right side view of the clamping mechanism of the tree pruner of FIGS. 1-5 with a lever of the clamping mechanism in the full close or locked position, according to an exemplary embodiment.

FIG. 7 is a rear view of the clamping mechanism of the tree pruner of FIG. 6, according to an exemplary embodiment.

FIG. 8 is a right side view of the clamping mechanism of the tree pruner of FIG. 6 with the lever of the clamping mechanism in the full open or unlocked position, according to an exemplary embodiment.

FIGS. 9A-9B are top views of the clamping mechanism of the tree pruner of FIG. 6 with the lever of the of the clamping mechanism in a full open position (FIG. 9A) and in a full close position (FIG. 9B), according to exemplary embodiments.

FIGS. 10A-10B are front cross-sectional views of the clamping mechanism of the tree pruner of FIG. 6 with the lever of the clamping mechanism in a full open position (FIG. 10A) and the lever in a full close position (FIG. 10B), according to exemplary embodiments.

FIG. 11 is a right side view of a clamping mechanism for an adjustable length tool, such as a tree pruner, with a lever of the clamping mechanism in the full close or locked position, according to another exemplary embodiment.

FIG. 12 is a rear view of the clamping mechanism of FIG. 11, according to an exemplary embodiment.

FIG. 13 is a top view of the clamping mechanism of FIG. 11, according to an exemplary embodiment.

FIGS. 14A-14F are top view illustrations of a lever of the clamping mechanism of FIGS. 11-13 moving from a full open/fully unlocked position (FIG. 14A) to a fully closed/fully locked position (FIG. 14F) along with various intermediate positions (FIGS. 14B-14E), according to exemplary embodiments.

FIG. 15 is a graphical representation of the changing distance between a part of the body of the clamping mechanism and a pivot connection of the lever of the clamping mechanism at each position of FIGS. 14A-14F, according to an exemplary embodiment.

FIG. 16 is a graphical representation of the changing distance between a pair of ribs of the body of the clamping mechanism at each position of FIGS. 14A-14F, according to an exemplary embodiment.

### DETAILED DESCRIPTION

Referring to the Figures generally, a clamping mechanism structured to selectively lock and unlock a movable pole relative to a user engagement pole of an adjustable length tool, such as a tree pruner, to enable/disable adjustment of an extension length of the movable pole relative to the user engagement pole is provided according to various embodiments herein. As described more fully herein, the clamping mechanism includes a body and a lever rotatably coupled to the body. The body may be structured to couple to a first part of the tree pruner, the first part representing a user engagement pole or outer pole of the tree pruner. A movable pole or inner pole of the tree pruner may be disposed within the user engagement pole, such that the movable pole may translate or move relative to the user engagement pole in order to vary the total length of the tree pruner to advantageously reach tree elements at differing heights relative to a ground surface. In operation, a user actuates the lever of the clamping mechanism to an unlocked position. The user may then pull or extend the movable pole from the user engagement pole. After the movable pole is pulled to a desired length from the user engagement pole, the user may actuate the lever to the fully closed or locked position. During rotation of the lever to the locked position, a cam of the lever engages with a first rib of the body to push or force the first rib of the body closer to a second rib of the body. Movement of the first rib towards the second rib causes a cross-sectional area of a top portion of the body of the clamping mechanism to deform (e.g., a reduction in the circumference of the top portion of the body). Deformation or reduction in circumference of the top portion of the body increases a friction amount between the top portion of the body and the movable pole. As a result of this deformation causing an increased amount of friction, movement of the movable pole relative to the user engagement pole is prevented or substantially prevented. In addition to the cross-sectional area deformation, in certain embodiments, actuation of the lever into the fully locked position creates an audible noise. This audible noise (e.g., a click sound) may provide an indication to the user that the clamping mechanism is in the locked position and act as a secondary locking feature relative to the primary locking feature (i.e., the cross-sectional area deformation/reduction in circumference feature). In this regard, the secondary locking feature—the snap-engagement of the lever to the body of the clamp—may also function to retain or substantially retain the lever in the fully locked position to thereby prevent or substantially prevent an undesirable unlock event from occurring (e.g., during use of the tree pruner).

Beneficially, the clamping mechanism of the present disclosure provides several advantages. Rotation of the lever is relatively easier and quicker than conventional twisting mechanisms used with conventional adjustable length tools, such as conventional tree pruners, because the lever is only needed to rotate substantially one-hundred eighty (180) degrees between the unlocked and locked positions compared to conventional tools that require multiple three-hundred and sixty (360) degree revolutions of their locking mechanisms. Moreover and because only a limited amount of rotation is needed for the lever to move between the locked and unlocked position, relatively less grip strength is needed compared to conventional adjustment mechanisms, which may appeal to users generally and especially to those users suffering from low hand strength. As a result, an increase in a duration of use of the adjustable length tool, such as a tree pruner, may be realized by users due to experiencing relatively less fatigue from using the tool. Additionally, the reduction in circumference ensures or substantially ensures that relative movement is prevented (i.e., that the movable pole will not move upon locking). In conjunction, the audible snap or click of the lever into the locked position allows a user to know, with confidence that the clamp is in the locked position. Beneficially, users may then use the tool with confidence knowing that the movable pole will not move during use. These and other features and benefits are explained more fully herein below.

As used herein, the terms “locked position,” “fully locked position,” “closed position,” or “fully closed position” are used interchangeably to refer to the position of the lever of the clamping mechanism in a full engagement position with a top portion of the body of the clamping mechanism. In other words, in the locked position, the lever has rotated a maximum or a substantial maximum amount in a direction towards the body. In comparison and as used herein, the terms “unlocked position,” “fully unlocked position,” “open position,” or “fully open position” are used interchangeably and refer to the position of the lever of the clamping mechanism being at a maximum or substantially maximum distance from a top portion of the body of the clamping mechanism. In other words, in the fully unlocked position, the lever has been rotated to a maximum or a substantial maximum amount away from the top portion of the body of the clamping mechanism. In comparison, in the “partial open position” or “partial unlocked position” refers to the lever being in any position before the locked position.

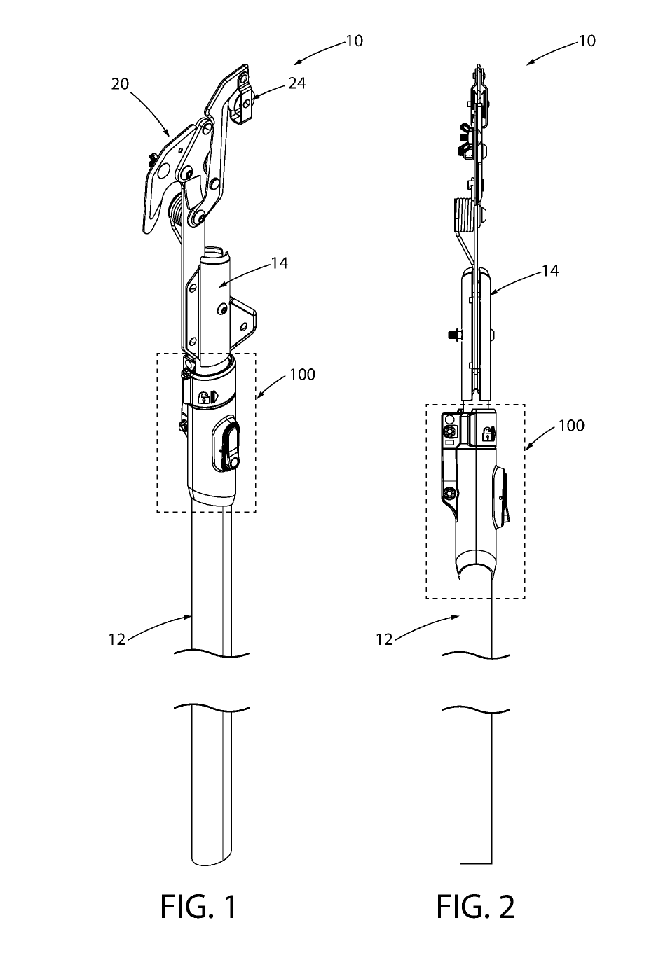

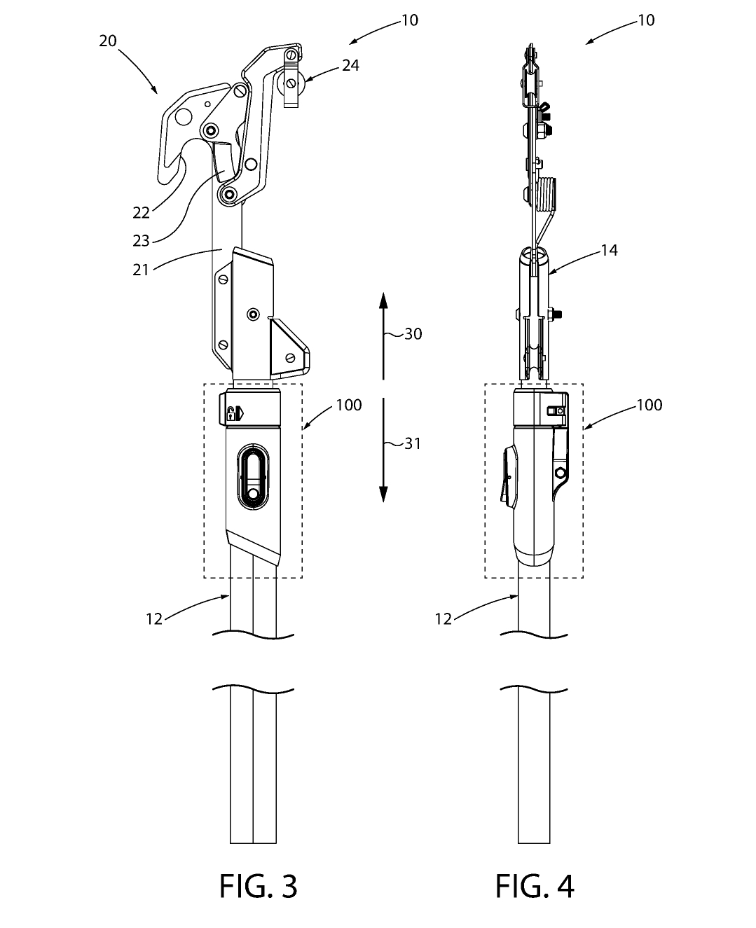

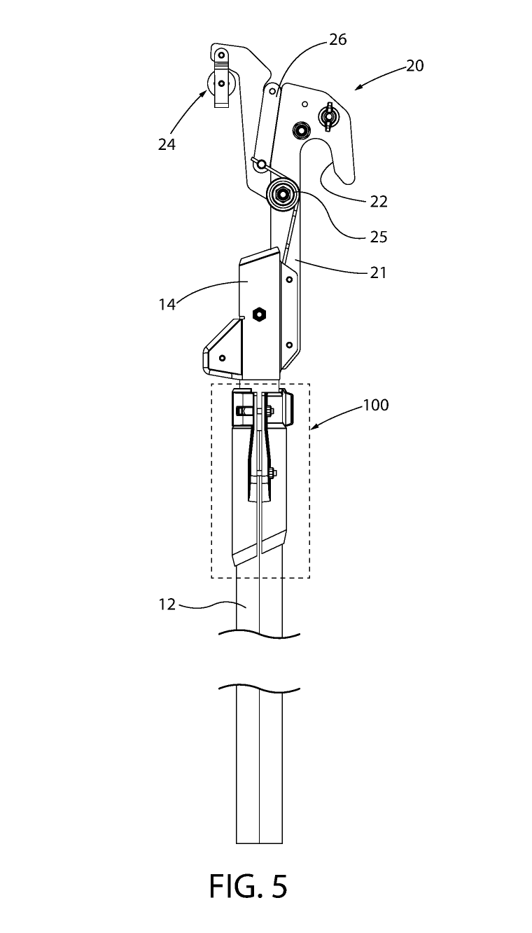

Referring now to FIGS. 1-5, an adjustable length tool, shown as a tree pruner, with a clamping mechanism of the present disclosure is shown according to one embodiment. As shown, the tree pruner 10 generally includes a user engagement pole 12, a movable pole 14 movably coupled to the user engagement pole 12, a pruning system 20, and a clamping mechanism 100 structured to selectively enable, permit, or allow movement of the movable pole 14 relative to the user engagement pole 12 to increase or decrease the distance between the pruning system 20 and the clamping mechanism 100 (i.e., increase or decrease a total length of the tree pruner 10). In particular and as shown most clearly in FIG. 3, actuation of the clamping mechanism 100 into an unlocked position enables the movable pole to move, slide, or translate in a first direction 30 and a second direction 31. In the first direction 30, the movable pole 14 moves away from the clamping mechanism 100 and user engagement pole 12 to increase a total length of the tree pruner 10. In the second direction 31, the movable pole 14 moves towards the clamping mechanism 100 and user engagement pole 12 to decrease a total length of the tree pruner 10. Before turning to the specifics of the clamping mechanism 100, the various other components of the tree pruner 10 are firstly described.

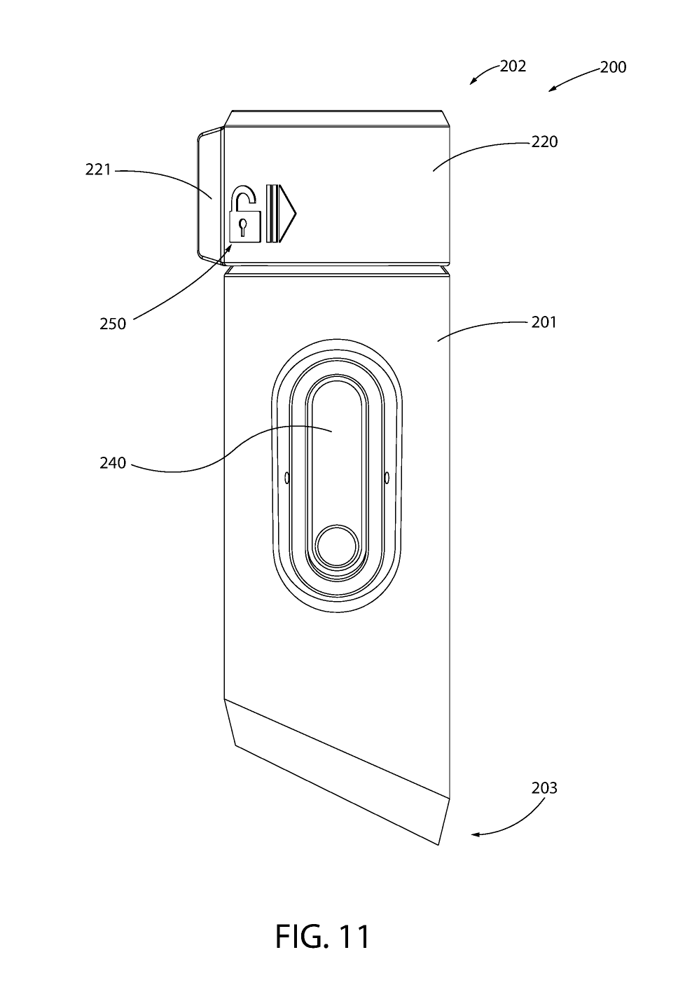

The user engagement pole 12 (also referred to herein as: a user engagement portion and a user engagement tube; an outer member, outer tube, outer pole, and outer portion; and/or, the first part, first portion, first pole, or first tube) defines a user interface of the tree pruner 10 for a user or operator to grip for using, carrying, or otherwise holding the tree pruner 10. In this regard, the user engagement pole 12 may be sized and structured to enable a user to utilize their palm of one or both of their hands to grip when carrying, holding, and/or using the tree pruner 10. Accordingly, the size and shape of the user engagement pole 12 is highly configurable. For example, the length of the user engagement pole 12 may vary based on a manufacturing model of the tree pruner 10 or a certain desire of a producer/manufacture of the tree pruner 10 (e.g., thirty-six inches in length, forty-eight inches in length, etc.). Similarly, a circumference and external shape of the user engagement pole 12 may also be highly configurable. As shown, the user engagement pole 12 defines an oval or oblong shape and is of a hollow structure to enable reception of the movable pole 14 therein. Of course, in other embodiments, the user engagement pole 12 may be of any external shape, cross-sectional shape, of any length, and of any size circumference. For example, a substantially circular cross-sectional shape is shown in regard to FIGS. 11-13. However, in other embodiments, a square, rectangle, or an assortment of various other external and/or cross-sectional shapes may be used. In certain embodiments, the user engagement pole 12 may also include an type of grip surface to prevent or substantially prevent grip slippage of the user's hand(s) on the pole 12. The grip surface may be disposed on one or more selected locations, zones, or areas on the user engagement pole 12 and be structured to have any shape desired. Thus, the configuration of the user engagement pole 12 is highly variable with all such variations intended to fall within the scope of the present disclosure.

As mentioned above, the movable pole 14 is sized and structured to be received, at least partly, within the user engagement pole 12. In this regard, the cross-sectional shape of the user engagement pole 12 may be any shape structured to enable the reception of the movable pole 14 therein. Accordingly, in one embodiment, the cross-sectional shape of the user engagement pole 12 matches or substantially matches an external shape of the movable pole 14. In the example depicted in FIGS. 1-5, the movable pole 14 has an external oval shape while the user engagement pole 12 defines an oval or substantially oval cross-sectional shape. In this regard and in one embodiment, “matching” or “substantial matching” means the same shape (i.e., an oval cross-sectional shape of the user engagement pole 12 to an oval outer shape of the movable pole 14). In another embodiment, “matching” or “substantial matching” means a same or different shape as long as i) the movable pole 14 may slidably move within the user engagement pole 12 and ii) the movable pole 14 may selectively engage with the clamping mechanism 100 to substantially prevent movement of the movable pole 14 when the clamping mechanism 100 is actuated into the full locked position. Thus, the cross-sectional shape of the user engagement pole 12 and the external shape of the movable pole 14 are highly configurable with all such variations intended to fall within the scope of the present disclosure.

The movable pole 14 (also referred to herein as: a movable portion or a movable tube; an inner member, inner tube, inner pole, or inner portion; and/or, the second part, second portion, second pole, or second tube) is coupled to the pruning system 20 and at least partially disposed within the user engagement pole 12. In operation, the movable pole 14 may translate, slide, or otherwise move relative to the user engagement pole 12 and the clamping mechanism 100 to selectively adjust or change a total length of the tree pruner 10. Beneficially, such total length adjustment provides an ability of the tree pruner 10 to reach elements (e.g., tree branches) of varying heights relative to a ground surface.

After the movable pole 14 is received at least partially within the user engagement pole 12, various stop mechanisms may be used to prevent the movable pole 14 from escaping, leaving, or otherwise falling out from the user engagement pole 12 to become de-coupled (i.e., movement in the first direction 30 or second direction 31 to de-couple or disassemble the movable pole 14 from the user engagement pole 12). For example, a bottom of the user engagement pole 12 (furthest from the clamping mechanism 100) may include a cap that prevents the movable pole 14 from moving outside of the user engagement pole 12 during movement of the movable pole 14 in the second direction 31. Additionally, the pruning system 20 is shown to be of a greater cross-sectional size than the user engagement pole 12, such that once the pruning system 20 is coupled to movable pole 14, the cross-sectional size of the pruning system 20 may prevent the movable pole 14 from moving outside of the user engagement pole 12 when the movable pole is moved in the second direction 31. Various other mechanisms may include, but are not limited to, a tapered or non-uniform cross-sectional area of the user engagement pole 12 which prevents movement of the movable pole in the second direction 31 beyond a certain position; a retainer, such as a pin received through the user engagement pole, which acts as a physical stop or barrier for the movable pole from moving towards the user during use; etc. Thus, the movable pole 14 may only move, translate, or slide a certain or predefined distance within the user engagement pole 12. In this regard, a minimum total length of the tree pruner 10 may be instituted with the tree pruner 10.

While the aforementioned stop mechanisms are described in their structure and function of stopping the movable pole 14 from moving out of a bottom of the user engagement pole 12 (i.e., in the second direction 31 furthest from the clamping mechanism 100), similar or, in some embodiments, no type of stop mechanism may be used to prevent the movable pole 14 from evacuating or falling out of the user engagement pole 12 at a top opening of the user engagement pole 12 proximate the position of the clamping mechanism 100. For example, in some instances, the movable pole 14 may be removable from the user engagement pole 12 in order to enable a cleaning of the inner surface of the user engagement pole 12 and/or an outer surface of the movable pole 14 (i.e., the surfaces that may slide or rub against each other during movement and non-movement of the movable pole 14). Cleaning may be helpful to ensure that no or little impediments are present that may disrupt the relative movement of the movable pole 14 to the user engagement pole 12. However, in other embodiments, stop mechanisms like described above may be utilized to prevent a de-coupling of the movable pole 14 and user engagement pole 12 once the two poles are coupled.

The pruning system 20 is structured to cut, sever, snip, or otherwise prune various elements, such as a tree branch. As shown, the pruning system 20 includes a body 21, a first cutting member 22 (e.g., hook, blade, etc.), a second cutting member 23 (e.g., blade, etc.), and among other components, an actuation mechanism. As also shown, the pruning system 20 is coupled to the movable pole 14, such that movement of the movable pole 14 to different relative lengths from the clamping mechanism 100 also adjusts the relative distance of the pruning system 20 to the clamping mechanism 100. In this example, the actuation mechanism includes a pulley 24 that supports a cable (e.g., rope, etc.) operatively coupled to the second cutting member 23. In operation, a user may pull or otherwise actuate the cable, which causes actuation of the second cutting member 23. Movement of the second cutting member 23 towards the stationary first cutting member 22 causes a cutting or severing of the element. As shown, the first and second cutting members 22, 23 are generally of a hook-shape and are structured as cooperating blades. Of course, in other embodiments, any type of cutting member configuration may be used (e.g., serrated blades, a straight blade, a hook and anvil configuration, etc.).

As also shown, the pruning system 20 includes a biasing element, shown as a spring 25. The spring 25 is coupled to the second cutting member 23 via an arm 26 (e.g., member, lever, etc.). Actuation of the cable pulls the arm 26 to cause movement of the second cutting member 23 towards the first cutting member 22. The spring 25 may be structured to bias the second cutting member into a full open position where the first and second cutting members 22, 23 are separated by a maximum distance in order to provide a reception area (e.g., gap, opening, etc.) for the element to be cut or severed. The spring 25 may be of any type and stiffness desired and, in turn, may vary based on the configuration of the tree pruner (i.e., from a relatively stiff spring constant to a relatively not stiff spring constant).

It should be understood that in various other embodiments of the tree pruner 10, the tree pruner 10 may include additional, different, or less components than that depicted in FIGS. 1-5. For example, some embodiments may include a saw extending out from the first and second cutting members 22, 23. The saw may enable a user to saw a tree branch that may be too large to fit within the gap defined by the first and second cutting members 22, 23 when they are in the full open position. In still another embodiment, a different type of actuation mechanism may be used to cause movement of one or both of the cutting members 22, 23 to affect cutting. Thus, those of ordinary skill in the art will readily recognize and appreciate the wide configurability of the pruning system with all such modifications intended to fall within the scope of the present disclosure.

It should also be understood that many different materials may be used to construct or form the inner pole 12, outer pole 14, and pruning system 20. For example, in one embodiment, the inner and outer poles 12, 14 are constructed from lightweight composites. In this regard, the lightweight characteristic may promote ease of use amongst users. In another embodiment, at least one of the inner and outer poles 12, 14 are constructed from metal or metal alloys. This embodiment may be beneficial for more robust applications of the tree pruner 10. In still another embodiment, any combination of metal, metal alloys, composites (e.g., plastics, etc.), rubber, and the like may be used to construct the inner and outer poles 12, 14. Similarly, the pruning system 20 may be constructed from any one or more of a metal-based material, a composite, and the like based on the application.

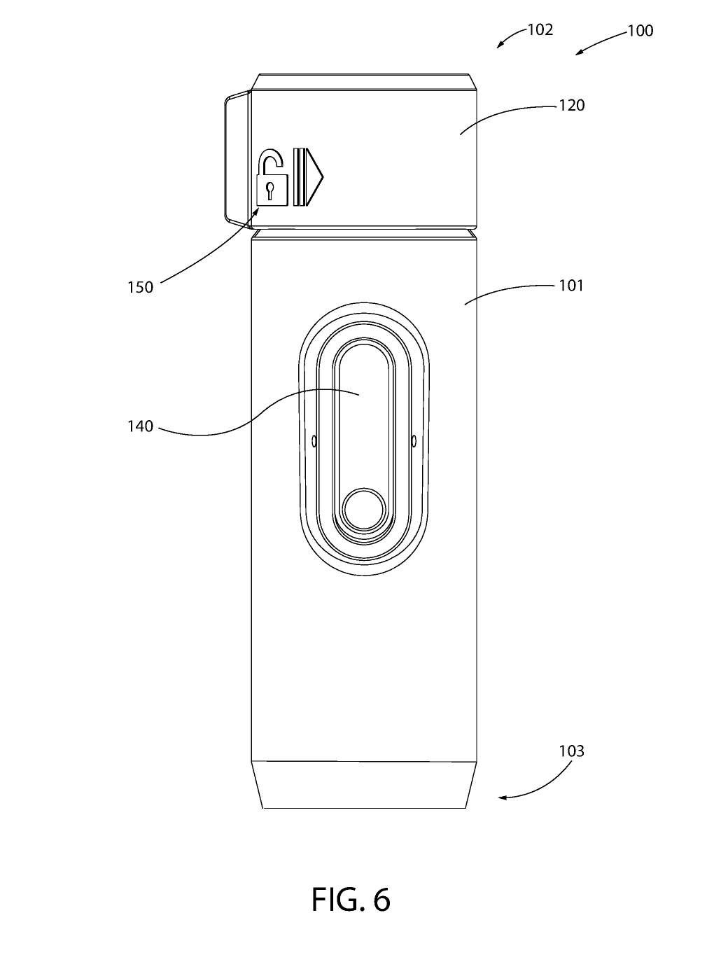

Turning now to the clamping mechanism 100, the clamping mechanism 100 (also referred to herein as the clamp) is structured to selectively hold or retain the movable pole 14 at a relative desired extension length from the user engagement pole 12. In this regard, the clamping mechanism 100 is actable between a locked position and an unlocked position. In the unlocked position, the movable pole 14 is permitted to slide, move, or otherwise translate relative to the user engagement pole 12. In the locked position, the movable pole 14 is substantially securable held or engaged with the clamping mechanism 100 to prevent or substantially prevent relative movement between the user engagement pole 12 and the movable pole 14. The function and structure of the clamping mechanism 100 is shown and explained in more detail in regard to FIGS. 6-10B.

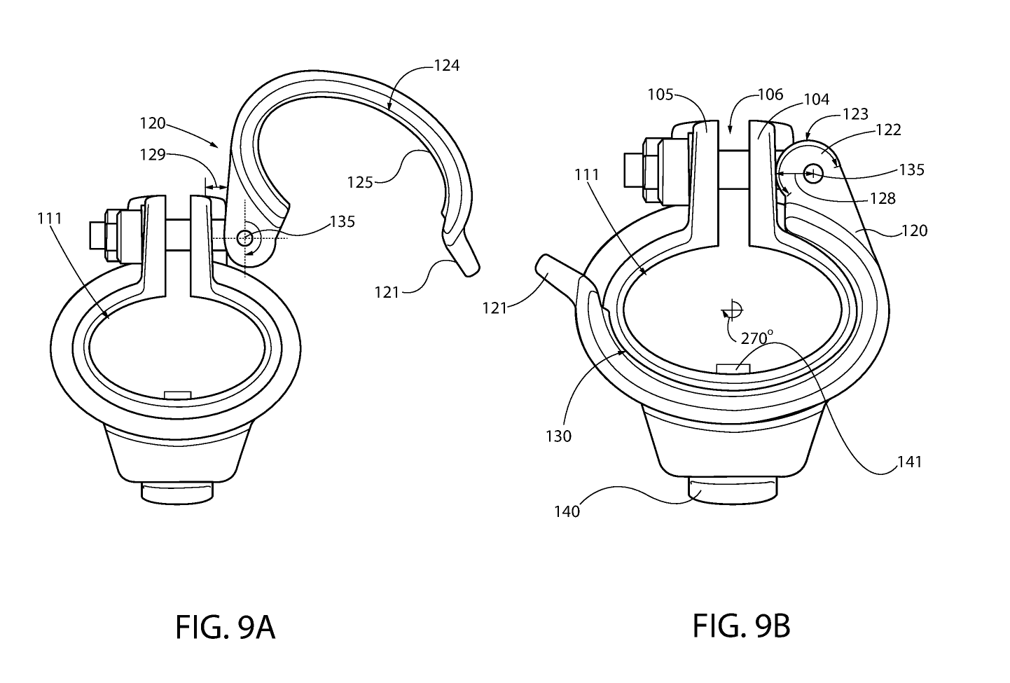

Accordingly, referring now to FIGS. 6-10B, the clamping mechanism 100 for the tree pruner 10 is shown, according to an exemplary embodiment. As shown, the clamping mechanism 100 generally includes a body 101 and a lever 120 rotatably coupled to the body 101. In operation, the lever 120 is rotatable from a full open position whereby the lever 120 is at a maximum separation distance and angle from the body 101 (see FIG. 9A) to a full closed position whereby the lever 120 is at least partly engaged with the body 101 (see FIG. 9B). When the lever 120 is not in the full locked position, the movable pole 14 may be movable relative to the clamping mechanism 100. In the full locked position, the lever 120 deforms an upper part or top part 110 of the body 101 to increase an amount of friction between the top part 110 and the movable pole 14 to squeeze the movable pole 14 and prevent or substantially prevent relative movement between the clamping mechanism 100 and the movable pole 14.

As shown, the body 101 generally includes a first or top end 102, a second or bottom end 103 opposite the top end 102, a first rib 104, a second rib 105, a top portion 110 interconnected with an edge 109 to a remainder of the body 101, and an opening 111 defined by the body 101. With references to FIGS. 1-5 and when the clamping mechanism 100 is included with the tree pruner 10, the top end 102 is disposed proximate the pruning system 20 while the bottom end 103 is disposed proximate the user engagement pole 12 or further from the pruning system 20 relative to the top end 102.

As mentioned above, the body 101 includes a first rib 104 and a second rib 105. The first and second ribs 104, 105 (e.g., splines, members, etc.) are disposed longitudinally along a part of the total longitudinal length of the body 101. As shown, the first and second ribs 104, 105 extend outward and way from a remaining portion of the body 101. Further, the first and second ribs 104, 105 are structured as substantially parallel oriented flanges. Of course, in other embodiments, the size and structure of the ribs 104, 105 may vary greatly (e.g., extend an entire length of the body 101, be a different shape than substantially rectangular like shown, extend further from or less than from the body 101 than depicted, etc.).

As also shown, the body 101 defines a gap 106 (e.g., opening, channel, space, void, separation gap, etc.). More particularly, the gap 106 is defined between the first rib 104 and the second rib 105. As also shown, the gap 106 extends the total length of the body 101. However, in other embodiments, the gap 106 may only be disposed in the top portion 110 of the body 101, extend only partially in the top portion 110 of the body 101, or any other length that still permits movement of the ribs towards each other. In this example, the body 101 may be structured as an integral piece with a separation gap 106, which acts to provide several benefits. For example, due to the separation gap 106 extending the total longitudinal length of the body 101, the body 101 may be able to withstand a relatively greater amount of flexion (in both directions: where the ribs 104, 105 are moved closer together or further apart) to thereby enable the body 101 to couple to relatively different shaped and sized user engagement poles 12. Such a benefit may be advantageous in manufacturing to enable limited body 101 sizes to be produced due to their ability to fit a wide range of sized and shaped user engagement poles.

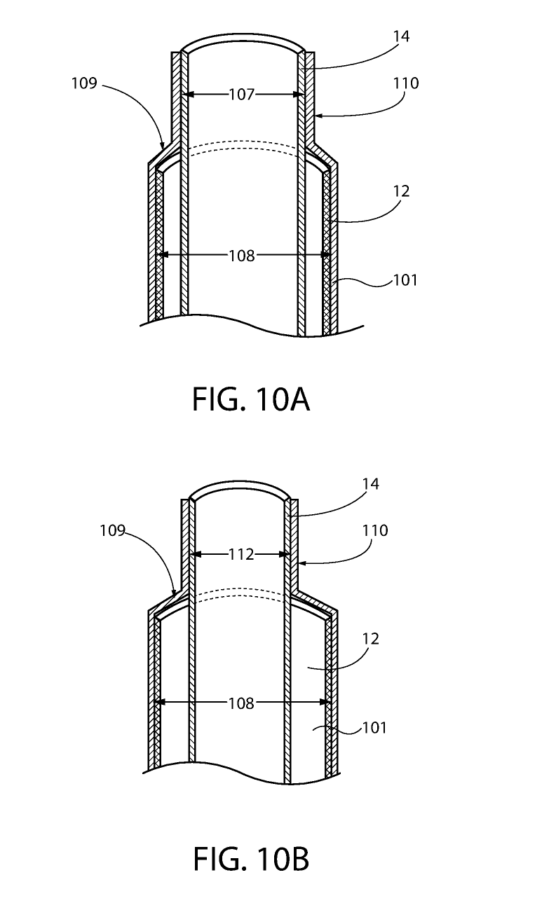

As shown in FIGS. 10A-10B, (a cross-sectional view of the body 101 when the lever 120 is in the full open position (FIG. 10A) and in the full close position (FIG. 10B)), the upper portion 110 (also referred to herein as top portion 110) defines a size 107 in the full open position (FIG. 10A) while the remainder of the body defines a size 108. For clarity, the lever 120 is not depicted in FIGS. 10A-10B. The sizes 107, 108 refer to cross-sectional sizes of the top portion 110 and remainder of the body 101, respectively. In this regard, the cross-sectional sizes 107, 108 may refer to a diameter value if the body is substantially cylindrical shape, may refer to a major length for an oval shape like depicted in the example of FIGS. 6-10B, may refer to a length value if the body is rectangular shaped, etc. More generally, the sizes 107, 108 refer to any metric that may be used to describe or quantify the cross-sectional area, shape, and/or size of the body 101 and the top portion 110 in the full open position. In this regard, the sizes 107, 108 may referred to as cross-sectional sizes 107, 108 for the purposes of description herein. As shown, the cross-sectional size 107 of the top portion 110 is relatively smaller than the cross-sectional size 108 of the remainder of the body 101. In this regard, an edge 109 (shown as a chamfered edge) may be utilized to decrease the cross-sectional size 108 to the cross-sectional size 107. In operation, the cross-sectional size 108 is structured to be of a size and shape to receive or engage with the user engagement pole 12 (i.e., the user engagement pole 12 is disposed within at least part of the body 101) while the cross-sectional size 107 is structured to be of a size and shape to selectively engage with the movable pole 14.

With the above description in mind, coupling of the body 101 to the user engagement pole 12 may be described as follows. The bottom end 103 of the body 101 may be slid over a top edge or part of the user engagement pole 12 (i.e., proximate the pruning system 20 when the tree pruner 10 is assembled). Due to the size reduction from cross-sectional size 108 to cross-sectional size 107 and the edge 109, only a portion of the body 101 may be disposed about the user engagement pole 12. Beneficially, the aforementioned size reduction and edge 109 act as a physical stop or barrier for the body 101 as the body 101 is slid or moved over the user engagement pole 12. In this regard, guesswork regarding how far down from the top of user engagement pole 12 that the body 101 should be disposed by assembly persons/technicians is substantially avoided, which may facilitate relative more efficient assembly. In some embodiments, an adhesive may be applied to one or both of a portion of the body 101 and a top portion of the user engagement pole 12 to securably retain the body 101 to the user engagement pole 12. In other embodiments, one or more fasteners may be used to couple the body 101 to the user engagement pole 12 (e.g., a pin through at least part of each of the body 101 and the user engagement pole 12, a bolt through at least part of each of the body 101 and the user engagement pole 12, etc.). In still other embodiments, one or more fasteners and adhesive may be used.

After the body 101 has been fully inserted or moved onto the user engagement pole 12, a bottom or lower part of each of the first and second ribs 104, 105 are structured to receive a first fastener 113 (proximate the bottom end 103 of the body) while a top or upper part of each of the first and second ribs 104, 105 (proximate the top end 102 of the body 101) are structured to receive a second fastener 114. The fasteners 113, 114 may include bolts, pins, screws, and any other type of fastener. After the body 101 is slid, moved, or otherwise positioned on a top or upper portion of the user engagement pole 12, the first and second fasteners 113, 114 may be used to couple, join, or otherwise attach the first rib 104 to the second rib 105. Tightening of the fasteners 113, 114 may then cause movement of the ribs 104, 105 closer together (i.e., to decrease the separation gap 106) to thereby tighten or secure the body 101 to the user engagement pole 12. As described above, in certain embodiments, adhesive and/or one or more fasteners may also be used to also help securably retain the body 101 to the user engagement pole 12.

As shown particularly in FIGS. 10A-10B, after coupling of the body 101 to the user engagement pole 12, the top portion 110 of the body 101 is disposed above the user engagement pole 12. That is to say, the top portion 110 of the body 101 extends above and over the user engagement pole 12 when the body 101 is coupled to the user engagement pole 12. In this regard, the top portion 110 of the body 101 is not or substantially not in contact with the user engagement pole 12. As a result and as described more fully herein below, actuation of the lever 120 into the full locked position can cause deformation of the top portion 110. In turn, deformation of the top portion 110 of the body 101 may relatively securably engage with the movable pole 14 to substantially prevent relative movement of the movable pole 14 relative to the clamping mechanism 100 when the lever 120 is in the locked position.

As mentioned above, the body 101 is shown to define an opening 111. The opening 111 (e.g., space, void, etc.) is defined, more particularly, by the top portion 110 and proximate the top end 102. According to one embodiment, the opening 111 corresponds with a shape of an external shape of the movable pole 14. Thus, in this example, the opening 111 is of an oval or substantially oval shape. In operation, the movable pole 14 may slide, translate, or otherwise move through the opening 111.

Still referring to FIGS. 6-10B and as described above, the lever 120 is movable, rotatable, or actuable between a full closed position (i.e., locked position) and a full open position (i.e., unlocked position), which is shown in FIG. 9A (full open position) and FIG. 9B (full close position). In the example depicted and with reference to FIG. 9A, the lever 120 is rotatable approximately one-hundred and eighty (180) degrees about a pin 135. Beneficially, such a limited amount of rotation to lock/unlock the clamping mechanism 100 may increase an ease of use of the clamping mechanism 100 as compared to conventional mechanisms. For example, twist mechanisms may require multiple complete revolutions (i.e., multiple three-hundred sixty (360) degree revolution) to actuate locking/unlocking. As shown, the lever 120 generally includes a tab 121, a cam 122 having a cam surface 123, a cross-sectional value 124, an inner surface 125 that is proximate and at least partly engaged with the top portion 110 of the body 101 when the lever 120 is in the locked position, and first and second prongs 126 and 127. Before turning to the description of each of the aforementioned components, the lever 120 overall is firstly described.

In the embodiment depicted, the lever 120 is of unitary construction. In other words, the lever 120 is structured as a one-piece component plus a pin 135 (described below) that rotatably couples the lever 120 to the body 101. Beneficially, a one-piece component may facilitate relatively faster production and assembly of the clamping mechanism 100. Of course, in other embodiments, the lever 120 may be constructed from two or more pieces. All such variations are intended to fall within the scope of the present disclosure.

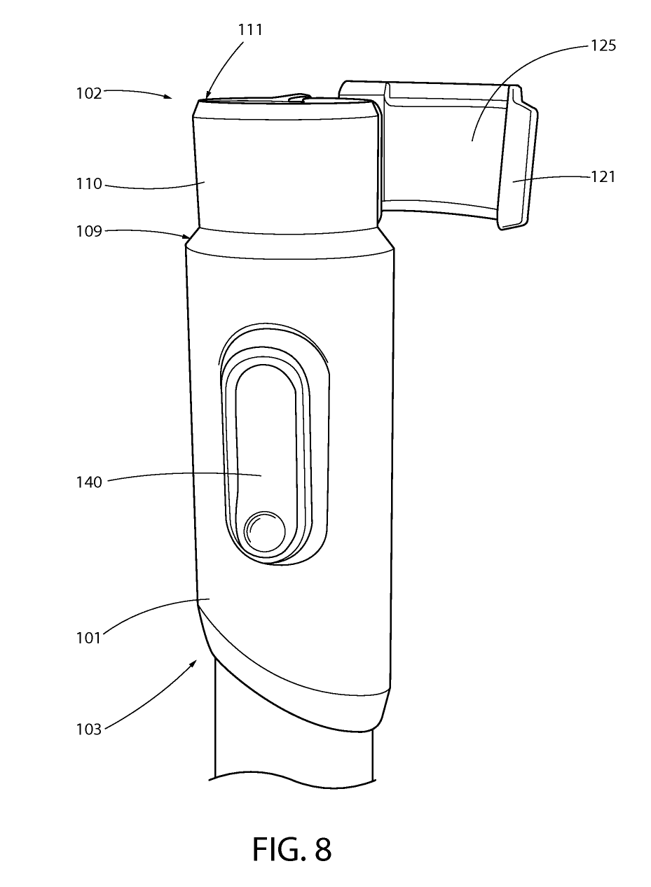

As shown particularly in FIGS. 8-9B, a shape of the lever 120 matches or substantially matches an external shape of the top portion 110 of the body 101 (where “external” refers to the shape of the top portion 110 not proximate the movable pole 14 when the tree pruner 10 is assembled). Thus, in the embodiment of FIGS. 6-10B, the general shape of the lever 120 is oval, which corresponds with the oval shape of external surface of the top portion 110 of the body 101. In this regard, the cross-sectional value 124 corresponds with a matching or substantially matching oval-shape to the external shape of the top portion 110. Of course, in other embodiments, the cross-sectional value 124 may be of any shape and size that corresponds with an external shape of the top portion 110 in order to allow or substantially allow engagement or mating of the lever 120 with the top portion 110 in the full locked position.

As shown, the lever 120 does not extend fully about the top portion 110. Rather, as shown in FIG. 9B in the full close position, the lever 120 extends approximately two-hundred and seventy (270) degrees about the top portion 110. In other embodiments, the lever 120 may extend a different amount. For example, in another embodiment, the lever 120 may extend any amount about the top portion 110 that is greater than ninety (90) degrees, that is greater than or equal to ninety (90) degrees, etc. Thus, the extension amount depicted in the Figures is not meant to be limiting as the present disclosure contemplates a wide variety of extension amounts with all such variations intended to fall within the scope of the present disclosure.

As mentioned above, the lever 120 corresponds with an oval or substantially oval shape in the embodiment of FIGS. 6-10B. More particularly, the inner surface 125 of the lever 120, which corresponds with the cross-sectional value 124, is sized and shaped to correspond with an external surface of the top portion 110 of the body 101. In this regard, the lever 120 is coupled to the body 101 to correspond or substantially correspond with the top portion 110 of the body 101. The oval or substantially oval shape of the surface 125 of the lever 120 may match the external shape of the top portion 110. As a result, actuation of the lever 120 into the locked position may cause deformation of a cross-sectional area of the top portion 110 to squeeze, engage, or otherwise substantially securably retain the movable pole 14. Of course, in other embodiments, the shape of the surface 125 of the lever 120 (in turn the shape of the cross-sectional value 124) may be any shape as long as the shape is capable of engaging with the top portion 110 to be substantially retained (e.g., not or substantially not movable out of the locked position) when the lever 120 is in the full locked position. In this regard and in some embodiments, the shape of the surface 125 corresponding to the cross-sectional value 124 may differ from an external shape of the lever 120. For example, the shape of the surface 125 of the lever 120 may define a cross-sectional value 124 that indicates a circular shape yet the top portion 110 is of a square external shape. Thus, a wide variety of shape and size configurations may be possible without departing from the scope of the present disclosure.

Beneficially and as shown, a thickness of the lever 120 (the portion that interfaces with the external oval shape of the top portion 110) substantially corresponds with a radial distance of the size reduction from size 108 to size 107 (i.e., the difference in external shape between an external surface of the top portion 110 and an external surface of the remainder of the body 101). In this regard and as shown in, for example, FIGS. 6 and 9B, placement of the lever 120 into the full closed position does not protrude or substantially protrude out relative to the remainder of the body 101 from the top portion 110. Advantageously, a more streamline, smooth, and pleasant outer appearance of the clamping mechanism 100 is provided by this feature.

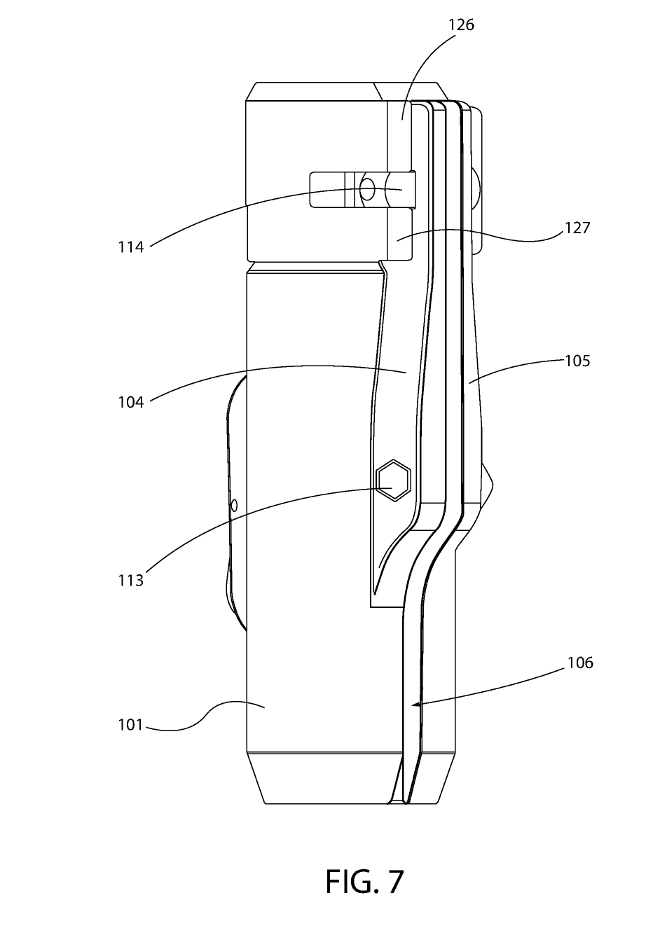

As mentioned above, the lever 120 is rotatably coupled to the body 101. In particular and as shown, the lever 120 is rotatably coupled to the top portion 110 of the body 101 by a pivot connection, shown as a pin 135. More particularly, the lever 120 is shown to be rotatably coupled to an end of the top fastener 114, which is disposed in a region of the body 101 corresponding to the top portion 110, via the pin 135. In other embodiments, any type of rotatable coupling mechanism may be used in addition to or in place of the pin 135 (e.g., a screw, etc.). In the example shown (see FIG. 7) and as mentioned above, the lever 120 includes a top prong 126 (e.g., first prong) proximate the top end 102 and a bottom prong 127 (e.g., second prong) proximate the bottom end 103. The prongs 126, 127 (e.g., members, etc.) at least partly surround the top fastener 114 and are structured to each, at least partly, receive the pin 135. In other embodiments, more than or less than two prongs may be used to couple to the body 101. For example, in an alternate embodiment, only one prong may rotatably couple the lever 120 to the body 101. In still other embodiments, different types of rotatably coupling mechanisms may be used to couple the lever 120 to the body 101.

As shown, the tab 121 extends outward and way from the remainder of the lever 120. The tab 121 (e.g., user engagement portion, lip, flange, etc.) corresponds to a user engagement portion of the lever 120. In this regard, a user may hold or grip the tab 121 to rotate, move, or otherwise actuate the lever 120 about the body 101.

As mentioned above, the lever 120 includes a cam 122 defining a cam surface 123. The cam 122 (also referred to as a cam member) is disposed substantially about the pin 135. As shown in the example of FIG. 7 and mentioned above, the prongs 126, 127 of the lever 120 are structured to at least partially surround the top fastener 114 in order to enable reception of the pin 135 through each of the prongs 126, 127 and the top fastener 114. For the purposes of explanation, the “cam 122” refers to each curved surface member on the lever 120 of each prong 126, 127 that is proximate to each of the pin 135 and the first rib 104. Based on the foregoing and as shown in FIG. 9B, the cam 122 corresponds with a cam surface 123, which at least partly surrounds the pin 135. As also shown, a distance 128 between the cam surface 123 and the pin 135 varies from the full open position of the lever 120 to the full close position. In this regard and as described herein, a force imparted on the first rib 104 by the cam 122 is variable or changes from the full open to full close position of the lever 120. An explanation of this feature may be described more fully with reference to FIGS. 9A-10B.

Accordingly, referring more particularly to FIGS. 9A-10B, operation of the lever 120 to effect the cross-sectional area deformation/reduction in circumference of the top portion 110 of the body 101 may be described as follows. In the full open position (FIG. 9A), the lever 120 is not engaged with the first rib 104; rather, as shown in FIG. 9A, a gap 129 is defined between the cam 122 and the first rib 104. However and due to the variable distance 128, during movement of the lever 120 to the full close position, the cam 122 (particularly, the cam surface 123) engages with the first rib 104. As the cam 122 engages with the first rib 104, a part of the lever 120 near the tab 121 engages or comes into contact with the top portion 110 of the body 101 during the transition from the full open position to the full close position. Engagement between the part of the lever 120 near the tab with the top portion 110 causes the lever 120 to flex outward and away from the top portion 110 in order to open and go around the top portion 110. The outward and open flexion of the lever 120 further causes the cam 122 to increase the force applied to the first rib 104. At or near a certain point (shown as point 130 in FIG. 9B), the outward and open flexion of the lever 120 substantially ceases and the inward flexion towards and around the top portion 110 of the body 101 begins. The inward flexion causes the lever 120 to “snap back” to encompass the top portion 110 of the body. The snap back may result in an audible sound, such as a click or snap noise, which alerts the user that the lever 120 is in the full close position. Furthermore and as shown in FIG. 9B, in the full close position, the cam 122 is in contact or engagement with the first rib 104 pushing or moving the first rib 104 towards the second rib 105. Movement of the first rib 104 towards the second rib 105 results in a decrease of the separation gap 106 in at least the area, zone, or region proximate the top portion 110 of the body 101. In this regard and with reference to FIG. 10B, upon actuation of the lever 120 into the locked position, the top portion 110 experiences a deformation, shown as size 112. The deformation may be in any direction (e.g., radially), which results in an increase in friction relative between the top portion 110 and the movable pole 14 relative to a friction amount in the full close position. In one embodiment, the “increase” in friction refers to any amount of friction in at least one engagement point between the movable pole 14 and the top portion 110 that may cause prevention of relative movement between the top portion 110 and the movable pole 14. To unlock the lever 120, a user grips the tab 121 and rotates the lever 120 counterclockwise (based on the view point depicted in FIG. 9B). During this movement, the inner surface 125 disengages from the top portion 110 of the body and the cam 122 disengages from the first rib 104. The deformation is then removed and the movable pole 14 is able to move, slide, or translate relative to the clamping mechanism 100 and user engagement pole 12.

Thus, actuation of the lever 120 into the full closed position corresponds with two locking features. The first locking features corresponds with the cross-sectional area deformation/reduction in circumference of the top portion 110 of the body 101, which causes an increase in friction between the top portion 110 and the movable pole 14 and, in turn, a relatively more secure engagement between the top portion 110 and the movable pole 14. The second locking feature corresponds with the physical and audible snap of the lever 120 into the locked position. Due to the lever 120 snapping back to the top portion 110 (i.e., the spring-like reflex) from the outward and then inward flexion, rotation to the unlocked position without a user force may be substantially prevented. Rather, a user force may be required to cause the outward flexion to disengage the lever 120 from the top portion 110. Thus, the physical and audible snap securably or substantially securably holds the lever 120 in the locked position. Additionally, the audible noise created by the snap may alert the user that the lever 120 is in the locked position such that the user may use the tree pruner 10 with confidence knowing that relative movement of the movable pole 14 will not or likely will not occur.

Before turning to another embodiment of the clamping mechanism, as also shown in FIGS. 6-10B, the clamping mechanism 100 in this example includes a switch 140, also referred to herein as a lock release button 140 or lock release mechanism 140, pivotably coupled to the body 101 and insignia 150 disposed on the lever 120. The insignia 150 (e.g., marking, an indicator, etc.) may be configured as a visual or graphical representation providing an indication of how to use the lever 120. In the example shown, the insignia 150 depicts an unlocked lock symbol with an arrow, whereby the arrow indicates the rotational direction of the lever to unlock the lever 120. Of course, in other embodiments, any other type of insignia may be used, no insignia may be used, or the insignia may be disposed in a different location than that depicted in the Figures.

As shown, the lock release button 140 (e.g., toggle, pin actuator, etc.) is pivotably or rotatably coupled to the body 101. Relative to the primary and secondary locking mechanisms, the switch 140 is a third or tertiary locking mechanism for preventing or substantially preventing relative movement of the movable pole 14 to the clamping mechanism 100 and user engagement pole 12. In particular and as shown in FIGS. 9A-9B, the switch 140 is operatively coupled to a pin 141 (e.g., protrusion, member, etc.). In this embodiment, the movable pole 14 may define a plurality of longitudinal spaced holes while the user engagement pole 12 defines a hole that enables the pin 141 to protrude through towards the movable pole 14. The holes of the movable pole and hole of the user engagement pole may be sized and shaped to receive the pin 141. Thus, after the user has moved the movable pole to the desired location relative to the clamping mechanism 100, the pin 141 may extend into one of the holes of the movable pole 14 to also provide a force or mechanism to hold the movable pole 14 in a desired extension length relative to the user engagement pole 12 and clamping mechanism 100. To facilitate easy engagement of the pin 141 into one of the holes of the movable pole 14, a biasing element (e.g., spring) may be used to bias the pin 141 towards a radial center of the user engagement pole 12 (i.e., towards the movable pole 14).

It should be understood that in other embodiments, the lock release button 140 may be excluded. In still other embodiments, a different type of tertiary locking mechanism may be used with the clamping mechanism 100. For example, in another embodiment, a pin tethered to the body may be removably inserted through the body and into a hole disposed in the movable pole. Thus, the switch 140 is not meant to be limiting as the present disclosure contemplates other and different types of locking mechanisms that may also be included with the clamping mechanism 100.

As mentioned above, a shape of the clamping mechanism may vary greatly based on at least one of a manufacturer's preference, an external shape of the user engagement pole, and an external shape of the movable pole. For example, the shape of the clamping mechanism may include, but is not limited to, circular, rectangular, square, etc. As another example, the shape of the user engagement pole and movable pole may differ (e.g., circular to oval), such that a shape of the body of the clamping mechanism coupled to the user engagement pole may differ relative to a shape of the top portion in order to engage with the different shapes of the inner and outer poles. All such variations are intended to fall within the scope of the present disclosure.

In this regard and referring now to FIGS. 11-13, a clamping mechanism for an adjustable length tool, such as the tree pruner 10, that is structured to selectively lock and unlock a movable pole relative to the clamping mechanism to restrict and permit relative movement is shown according to another embodiment. Relative to FIGS. 1-10B, the clamping mechanism 200 is of a generally cylindrical shape and corresponds with a substantially circular cross-section shape as compared to the substantially oval cross-sectional shape of the clamping mechanism 100. In the example of FIGS. 11-13, the movable pole (e.g., movable pole 14) and user engagement pole (e.g., user engagement pole 12) are not depicted for clarity. Nonetheless, it should be understood that the same or similar types of outer and inner poles may be used with the clamping mechanism 200. However, in this embodiment, the outer and inner poles may correspond with a circular or generally circular cross-sectional shape in order to correspond or substantially correspond with the shape of the clamping mechanism 200. Unless otherwise indicated, similar reference numbers are used with the clamping mechanism 200 to refer to similar components as in clamping mechanism 100 except with the “2” prefix. Thus, explanation of the clamping mechanism 200 is relatively shorter than that of the clamping mechanism 100 due to the overlap of similar components having a similar structure and function.

As shown, the clamping mechanism 200 (also referred to as clamp 200 and clamp mechanism 200) generally includes a body 201 and a lever 220 rotatably coupled to the body 201. In this example, the clamping mechanism 200 also includes a switch 240 (also referred to herein as a lock release button 240 or lock release mechanism 240) pivotably coupled to a pin 241, which may have the same or similar structure and function as described above in regard to the switch 140 and pin 141 described above in regard to the clamping mechanism 100. Thus and like the clamping mechanism 100, in certain embodiments, the switch 240 and pin 241 may be excluded from the clamping mechanism 200. In operation and like the lever 120, the lever 220 is rotatable from a full open position to a full closed position. When the lever 220 is not in the full locked position, the movable pole is at least partly movable relative to the clamping mechanism 200. In the full locked position, the lever 220 deforms an upper part 210 of the body 201 to increase an amount of friction to squeeze the movable pole to thereby prevent or substantially prevent relative movement between the clamping mechanism 200 and the movable pole. As shown, the body 201 generally includes a first or top end 202, a second or bottom end 203 opposite the top end 202, a first rib 204, a second rib 205, a top portion 210 interconnected with an edge 209 to a remainder of the body 201, and an opening 211 defined by the body 201.

The first and second ribs 204, 205 (e.g., splines, members, etc.) are disposed longitudinally along a part of the total longitudinal length of the body 201. As shown, the first and second ribs 204, 205 extend outward and way from a remaining portion of the body 201. Further, the first and second ribs 204, 205 are structured as substantially parallel oriented flanges. Of course, in other embodiments, the size and structure of the ribs 204, 205 may vary greatly (e.g., extend an entire length of the body 201, be a different shape than substantially rectangular like shown, extend further from or less than from the body 201 than depicted, etc.).

As also shown, the body 201 defines a gap 206 (e.g., opening, channel, space, void, separation gap, etc.). More particularly, the gap 206 is defined between the first rib 204 and the second rib 205. As shown, the gap 206 extends the total length of the body 201. However, in other embodiments and like the gap 106, the gap 206 may only be disposed in the top portion 210 of the body 201, extend only partially in the top portion 210 of the body 201, or any other length that still permits movement of the ribs towards each other. In this regard and in this example, the body 201 may be structured as an integral piece with a separation gap 206, which acts to provide several benefits like those described above in regard to the gap 106.

Coupling of the body 201 to a user engagement pole may be substantially similar to that described above in regard to the body 101 and the user engagement pole 12. Thus, a brief description may be described as follows. The bottom end 203 of the body 201 may be slid over a top edge or part of the user engagement pole (i.e., proximate the pruning system when the tree pruner is assembled). Due to the size reduction from a remainder of the body 201 to that of the cross-sectional size in top portion 210 (like the cross-sectional size 108 to cross-sectional size 107 of the clamping mechanism 100) and the edge 209, only a portion of the body 201 may be disposed about the user engagement pole. Accordingly, the size reduction and edge 209 act as a physical stop or barrier for the body 201 on the user engagement pole. In some embodiments and like described, In still other embodiments, one or more fasteners and adhesive may be used to help retain the body 201 to the user engagement pole. After the body 201 has been fully inserted or moved onto the user engagement pole, a bottom or lower part of each of the first and second ribs 204, 205 are structured to receive a first fastener 213 (proximate the bottom end 203 of the body) while a top or upper part of each of the first and second ribs 204, 205 (proximate the top end 202 of the body 201) are structured to receive a second fastener 214. The fasteners 213, 214 may include bolts, pins, screws, and any other type of fastener. The first and second fasteners 213, 214 may be used to couple, join, or otherwise attach the first rib 204 to the second rib 205. Tightening of the fasteners 213, 214 may then cause movement of the ribs 204, 205 closer together (i.e., to decrease the separation gap 206) to thereby tighten or secure the body 201 to the user engagement pole 12.

Like the clamping mechanism 100, after coupling of the body 201 to the user engagement pole, the top portion 210 of the body 201 is disposed above a top portion of the user engagement pole. That is to say, the top portion 210 of the body 201 extends above and over the user engagement pole 12. In this regard, the top portion 210 of the body 201 is not or substantially not in contact with the user engagement pole. As a result, actuation of the lever 220 into the full locked position can cause deformation of the top portion 110 whereby deformation is not or substantially not prevented from the user engagement pole.

As mentioned above, the body 201 is shown to define an opening 211. The opening 211 (e.g., space, void, etc.) is defined, more particularly, by the top portion 210 and proximate the top end 202. According to one embodiment, the opening 211 corresponds with a shape of an external shape of the movable pole 14. Thus, in this example, the opening 211 is of a circular or substantially circular shape. In operation, the movable pole 14 may slide, translate, or otherwise move through the opening 211.

Relative to the configuration shown in FIGS. 1-10B, the top portion 210 defines a longitudinally extending rib or protruding part, shown as flats 212, that disrupt the circular shape of the opening 211 and cross-sectional configuration of the body 201 in general. The flats 212 (e.g., channels, members, etc.) may be used to couple with the inner pole of the tree pruner and prevent rotatable movement of the inner pole. Further, the flats 212 may be any shape. In other words, the flats 212 may prevent the inner pole from rotating relative to the clamping mechanism 200 and user engagement pole. In some embodiments, ribs, such as flats 212, may also be included with the user engagement pole or only included with the user engagement pole. The latter configuration may be beneficial to avoid having to produce ribbed and non-ribbed versions of the clamping mechanism. Relative rotational constraining mechanisms, such as the flats 212, may be beneficial to keep an orientation of the pruning system in a desired position. For example, in some instances, if relative rotation occurs, then use of the pruning system may be complicated or challenged. Such a rotational restricting mechanism may prevent this complication. It should be understood that in other embodiments, different and or other types of relative rotational constraining mechanisms may be used with all such variations intended to fall within the scope of the present disclosure.

As shown and like the lever 100, the lever 220 generally includes a tab 221, a cam 222 having a cam surface 223, a cross-sectional value 224, an inner surface 225 that is proximate and at least partly engaged with the top portion 210 of the body 201 when the lever 220 is in the locked position, and first and second prongs 226 and 227. The lever 220 may correspond with the same or similar characteristics or attributes as described herein above with respect to the lever 120 (e.g., be of unitary construction, extend only partially about the top portion 210, etc.).

In this regard, a shape of the lever 220 matches or substantially matches an external shape of the top portion 210 of the body 201. Thus, in the embodiment of FIGS. 11-13, the general shape of the lever 220 is circular, which corresponds with the substantially circular shape of external surface of the top portion 210 of the body 201. More particularly, the cross-sectional value 224 corresponds with a matching or substantially matching circular-shape to the external shape of the top portion 210. Further, the inner surface 225 of the lever 220, which corresponds with the cross-sectional value 224, is sized and shaped to correspond with an external surface of the top portion 210 of the body 201. In this regard, the circular or substantially circular shape of the surface 225 of the lever 220 matches the external shape of the top portion 210.

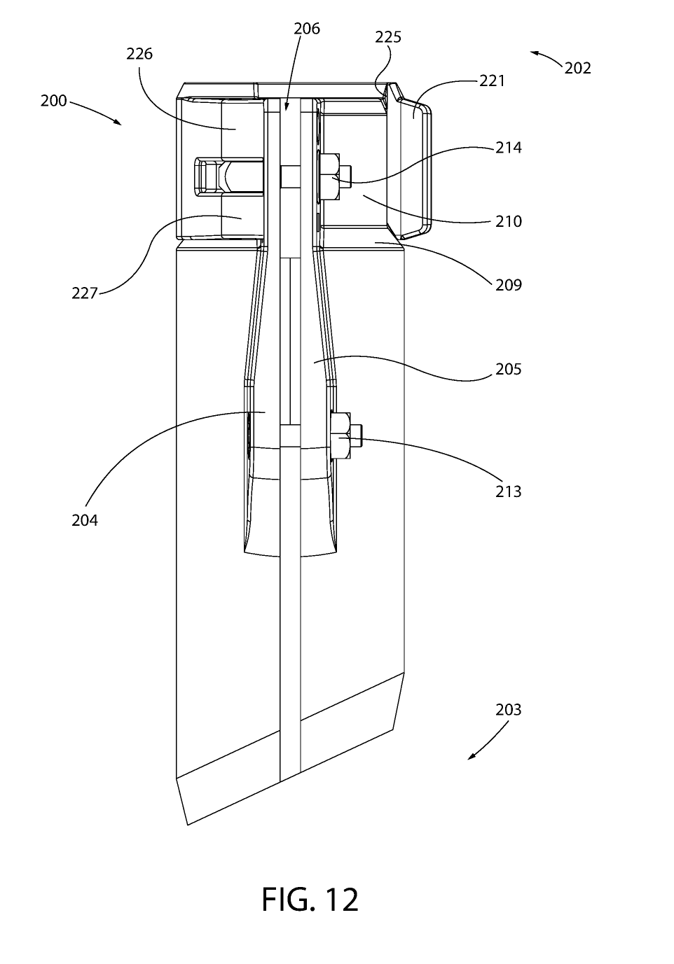

Like the lever 120, the lever 220 is rotatably coupled to the body 201. In particular and as shown, the lever 220 is rotatably coupled to the top fastener 214 via a pivot connection, shown as a pin 235, which is proximate a region associated with the top portion 210 of the body 201. In other embodiments, any type of rotatable coupling mechanism may be used in addition to or in place of the pin 235 (e.g., a screw, etc.). In the example shown (see FIG. 12) and as mentioned above, the lever 220 includes a top prong 226 (e.g., first prong) proximate the top end 202 and a bottom prong 227 (e.g., second prong) proximate the bottom end 203. The prongs 226, 227 (e.g., members, etc.) at least partly surround the top fastener 214 and are structured to each, at least partly, receive the pin 235. In other embodiments, more than or less than two prongs may be used to couple to the body 201. For example, in an alternate embodiment, only one prong may rotatably couple the lever 220 to the body 201. In still other embodiments, different types of rotatably coupling mechanisms may be used to couple the lever 220 to the body 201.

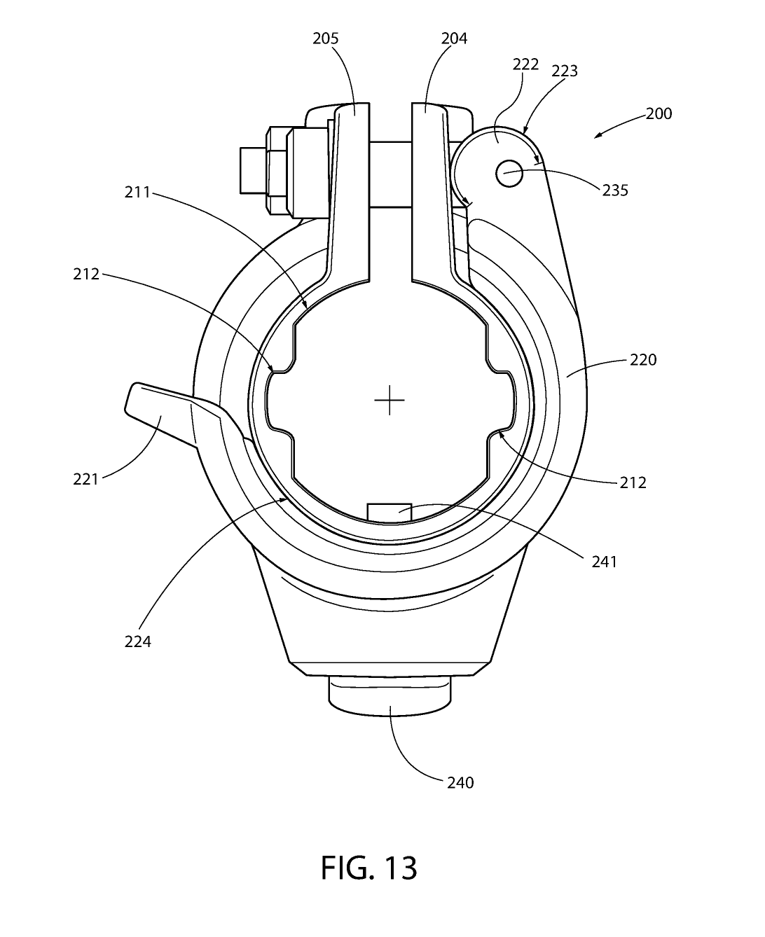

Similar to the lever 120, the lever 220 includes a cam 222 defining a cam surface 223. The cam 222 (also referred to as a cam member) is disposed substantially about the pin 235. As shown in the example of FIG. 13 and mentioned above, the prongs 226, 227 of the lever 220 are structured to at least partially surround the top fastener 214 in order to enable reception of the pin 235 through each of the prongs 226, 227 and the top fastener 214. For the purposes of explanation, the “cam 222” refers to each curved surface member on the lever 220 of each prong 226, 227 that is proximate to each of the pin 235 and the first rib 204. Based on the foregoing and as shown in FIG. 12, the cam 222 corresponds with a cam surface 223, which at least partly surrounds the pin 235.

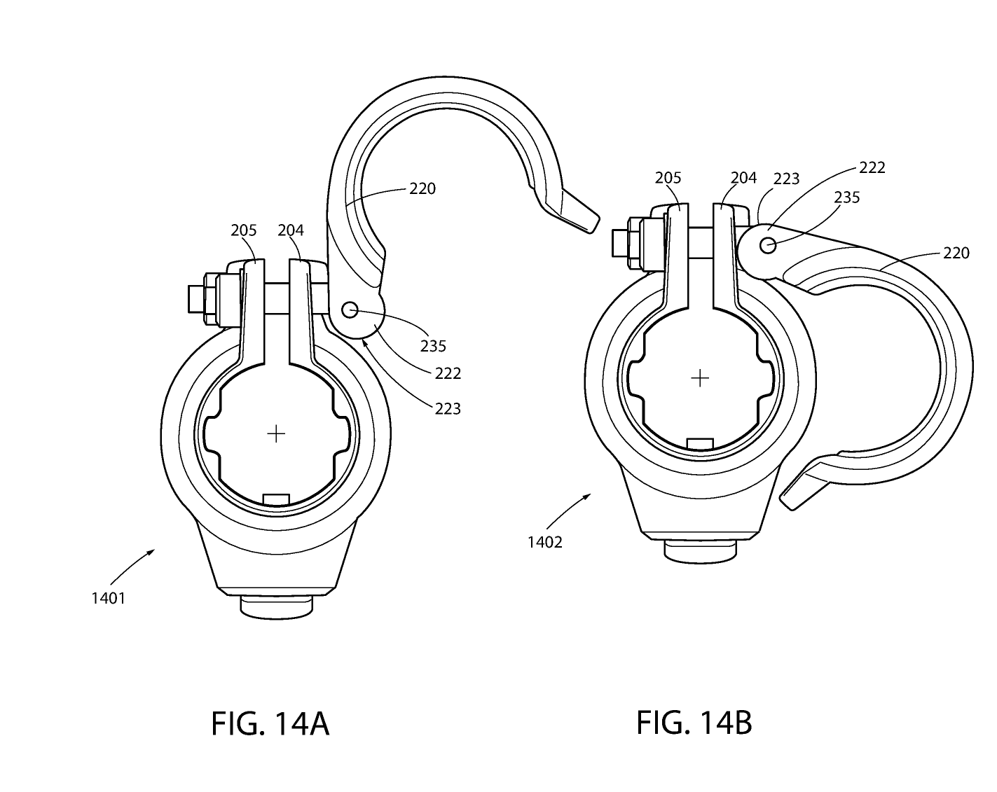

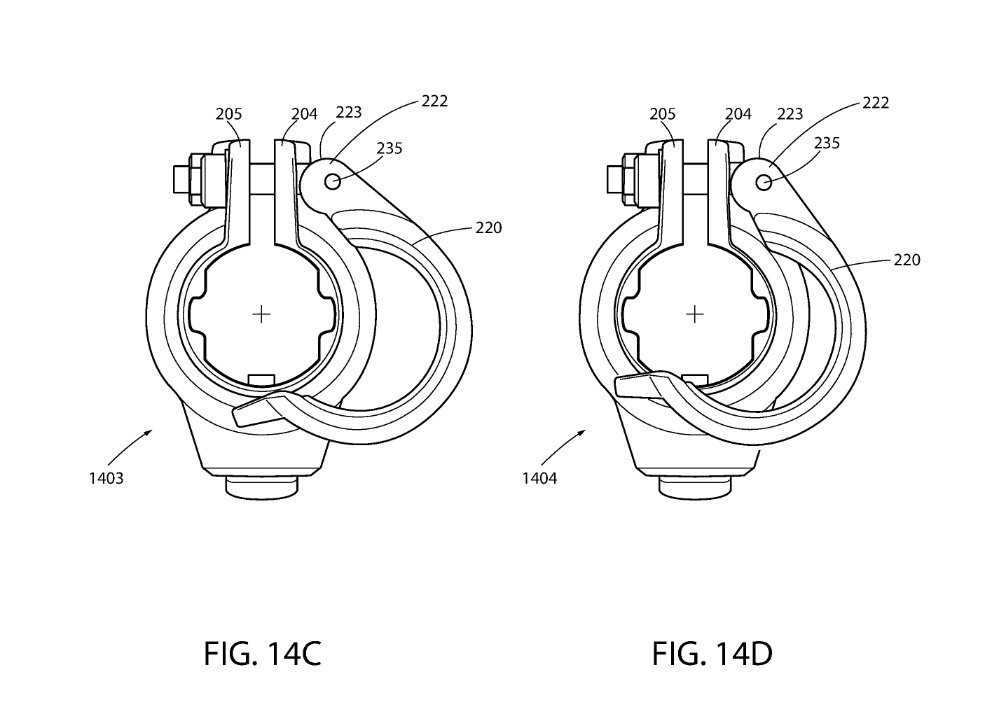

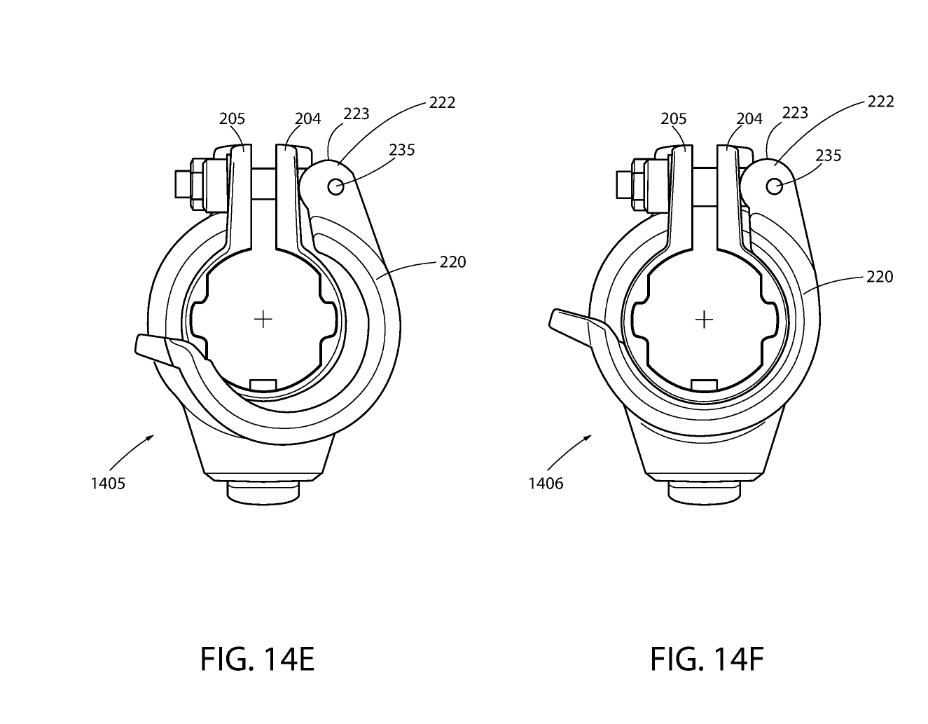

Similar to the lever 120, actuation of the lever 220 may correspond with primary and secondary locking mechanisms. Explanation of these mechanisms are shown in regard to FIGS. 14A-14F, which visually depict the movement of the lever 220 from the full open position (FIG. 14A) to the full close position (FIG. 14F).

With the above in mind, explanation may be described as follows. At image 1401, the lever 220 is in the full open position. In this regard, the lever 220 (namely, the tab 221) is separated by a maximum distance from the top portion 210. In the full open position, the cam surface 223 of the cam 222 is separated from the first rib 204. At image 1402, the lever 220 has been rotated clockwise (based on the view depicted in FIG. 14B) towards the top portion 210 and is in a partial unlocked or open position. However, the cam surface 223 of the cam 222 is still separated from the top portion 210. At image 1403, the lever 220 has been rotated clockwise further relative to image 1402. As a result, the cam surface 223 is engaged with the first rib 204 and beginning to cause the first rib 204 to move towards the second rib 205. Further, a part of the lever 220 near the tab 221 has begun to contact the top portion 210 of the body 211. Due to the beginning or initialization of movement of the first rib 204 towards the second rib 205, constrained relative movement between the clamping mechanism 200 and the inner pole may begin to be experienced by a user. At image 1404, the lever 220 has rotated clockwise even further relative to image 1403. As part of this rotation, the cam 223 of the cam 222 has pushed, moved, or otherwise forced the first rib 204 closer to the second rib 205 than in the image 1403. Further, due to the sliding contact/engagement of the part of the lever 220 near the tab 221 and the top portion 210 of the body 201, the lever 220 is flexing outward and away from the top portion 210 of the body 201. At image 1405, the lever 220 has rotated clockwise even further relative to the image 1404. Due to this rotation, the cam surface 223 of the cam 222 has continued to push on the first rib 204 to cause additional movement towards the second rib 205 to further deform a cross-sectional area/reduce the circumference of the top portion 210 of the body 201 relative to that in image 1404. At image 1406, the lever 220 has completed rotation into the full locked position. During the transition to this position, the lever 220 has sprung back or flexed back to partially encompass the top portion 210 to lock the lever 220 in place around (substantially) the top portion 210 of the body 201. In this regard, the lever 220 may be characterized as being seated with respect to the top portion 210 of the body 201. The inward flexion may result in the lever 220 to be held substantially securely around the top portion 210. As a result, this holding force has caused the cam 222-to-first rib 204 engagement to be maintained (i.e., the deformation of the cross-sectional area of the top portion 210 to be maintained). Therefore and in this full locked position, relative movement between the inner pole and the clamping mechanism 200 is substantially prevented.

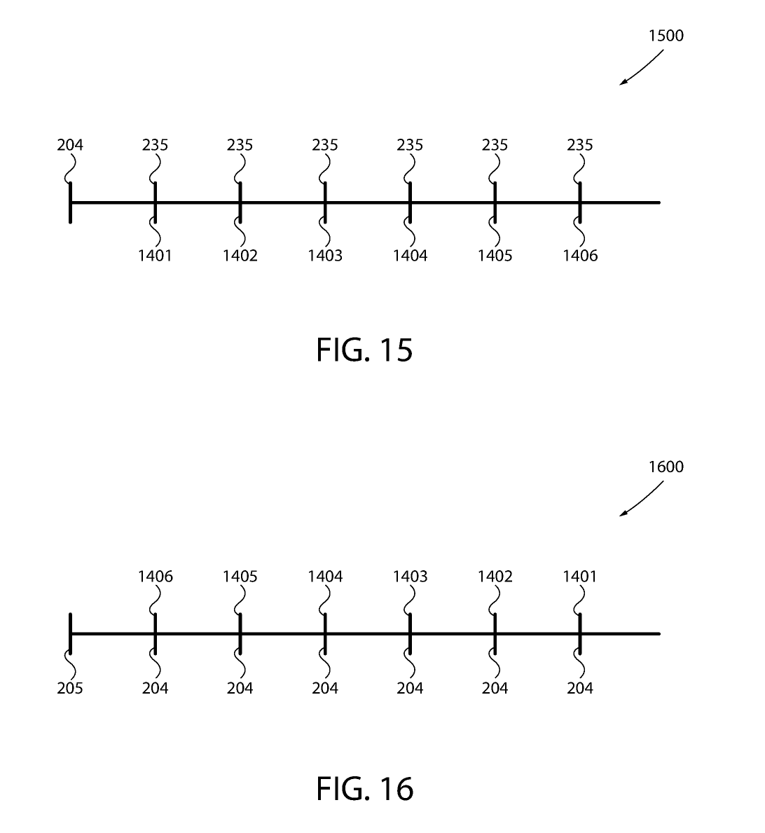

Further description of the clamping mechanism 200 may be described in regard to FIGS. 15-16. Graph 1500 depicts the change in distance between the first rib 204 and the pin 235 from the unlocked position to the locked position for the lever 220, according to an example embodiment. Graph 1600 depicts the change in distance between the first and second ribs 204 and 205 from the unlocked to locked position of the lever 220, according to an example embodiment. In regard to graph 1500, as can be seen, as the lever 220 is actuated to the locked position, the distance between the pin 235 and the first rib 204 increases in distance. This is due to the curve of the cam surface 223 of the cam 222. More particularly and with reference back to FIG. 9B where the distance 128 between the cam surface 123 and pin 135 is shown to be non-uniform or at least of a different value (e.g., increasing) at least once during the movement to the full lock position, a similar configuration is implemented with the lever 220. In this regard, as the lever 220 moves towards the full lock position, a distance (e.g., distance 128) between the cam surface 223 and the pin 235 increases. This results in the distance between the first rib 204 and the pin 235 increasing from the full open position to the full close position. The increase in distance may result in an increase in force on the first rib 204 towards the second rib 205. As a result and referring now to FIG. 16, a graph 1600 depicts the distance between the first rib 204 and second rib 205 decreasing as the lever 220 is actuated from the full open position to the full close position, according to an example embodiment. Due to the ribs 204, 205 moving closer together, the separation gap 206 also decreases as does the circumference of the top portion 210 of the body 201. As used herein, in some embodiments, the “deformation” may mean that the overall shape (i.e., circular like shown with respect to the clamping mechanism 200) stays the same or substantially the same, but the size/area or circumference decreases. In some other embodiments, the “deformation” may mean that the cross-sectional shape of the top portion 210 has changed (e.g., oval to circular, square to rhomboid, etc.). As a result of this deformation, an internal surface of the top portion 210 of the body 201 engages with an inner pole in a manner that prevents or substantially prevents translation, movement, or sliding of the inner pole relative to the clamping mechanism 200. That is to say, due to the deformation, an increase in friction between the top portion of the body and the inner or movable pole may increase to an amount that prevents or substantially prevents relative movement between the clamping mechanism and the inner pole.

It should be understood that while graph 1500 depicts that the distance between the pin and the first rib as increasing linearly (i.e., in a similar amount at each point 1401-1406) and as the distance between the first and second ribs decreasing linearly in graph 1600 (i.e., a similar amount at each point 1401-1406) that this depiction is for exemplary purposes only. In this regard and in other embodiments, the increase in distance between the pin and first rib and decrease in distance between the first and second ribs may be non-linear. In still other embodiments, rather than being a constant (linear or non-linear) increase in distance between the pin and the first rib and a constant (linear or non-linear) decrease in distance between the first and second ribs, there may be one or more periods (e.g., instances) of counter movement. For example, there may be a momentary decrease in distance between the pin and first rib during actuation of the lever to the full close position. As another example, there may be a momentary increase in distance between the first and second ribs during actuation of the lever to the full close position. Such counter-movements may be due to the inward/outward flexion of the lever during a movement into the full close position. For example, when the lever is at a maximum amount of outward flexion during movement to the full close position, a force from the cam on the first rib may be at its greatest amount, which causes a maximum amount of decrease in the separation gap between the first and second ribs. As the lever transitions into the full locked position, the flexion amount decreases and the force on the first rib towards the second rib also decreases thereby causing or allowing the first rib to move (slightly) away from the second rib.

Further, while the cam surface (e.g., surface 123 or 223) is shown to be of a substantially constant or uniform arcuate shape, in other embodiments, different curve types may be implemented with the cam members. In this regard, altering the surface profile of the cam surface may also impact the pin-to-first rib distance as well as the first rib-to-second rib distance characteristics at various positions during the movement of the lever from the full open position to the full close position. Moreover, such alterations may affect the final circumference deformation. The high configurability of the cam surface profile is intended to fall within the spirit and scope of the present disclosure.

It should also be understood that while FIGS. 14A-16 are described in regard to the clamping mechanism 200, the same or similar type of process and result is applicable with the clamping mechanism 100. In this regard, the same or similar engagements/results may be expected with respect to the clamping mechanism 100.

It is important to note that the construction and arrangement of the elements of the adjustable length hand operated tool, shown as a tree pruner, with a clamping mechanism is illustrative only. Although only a few embodiments have been described in detail in this disclosure, those skilled in the art who review this disclosure will readily appreciate that many modifications are possible without materially departing from the novel teachings and advantages of the subject matter recited.

Moreover, the clamping mechanism of the present disclosure may be constructed from a variety of different materials. For example, the use of engineered plastics in the construction of the clamping mechanism may provide a preferred combination of light weight and strength. According to other embodiments, a number of alternate materials can be used to produce the clamping mechanism: cast or machined aluminum could be utilized in the construction, a variety of steels, various composites, and/or any combination thereof.

Further, while the clamping mechanism is shown useable herein with only a tree pruner, it is contemplated that the clamping mechanism may be useable or applicable with any type of movable pole configuration where an inner pole is disposed at least partially within an outer pole and the inner pole is movable relative to the outer pole. For example, the clamping mechanisms of the present disclosure may be useable with pipes to alter an overall length of two coupled pipes. Thus, those of ordinary skill in the art will readily recognize and appreciate the wide applicability of the clamping mechanism.

Furthermore, all such modifications are intended to be included within the scope of the present disclosure. Other substitutions, modifications, changes and omissions may be made in the design, operating conditions and arrangement of the preferred and other exemplary embodiments without departing from the spirit of the present disclosure possible (e.g., variations in sizes, dimensions, structures, shapes and proportions of the various elements, values of parameters, mounting arrangements, use of materials, colors, orientations, etc.). Thus, one of ordinary skill in the art will appreciate that many modifications, alterations, or changes may be imparted into the tools disclosed herein without departing from the spirit and scope of the present disclosure.

For the purpose of this disclosure, the term “coupled” or other similar terms, such as “attached,” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present disclosure as expressed in the appended claims.

What is claimed is:

1. A clamping mechanism for an adjustable length tool, the clamping mechanism comprising:
a body having a top end, a bottom end opposite the top end, and a top portion proximate the top end; and
a lever rotatably coupled to the body between an unlocked position and a locked position, wherein the lever engages with the body during a movement of the lever to the locked position to cause a deformation of the top portion of the body;
wherein the deformation of the top portion of the body is structured to prevent relative movement between an inner pole of the adjustable length tool and the top portion of the body.

2. The clamping mechanism of claim 1, wherein the body includes a first rib and a second rib, wherein the first and second ribs extend at least partly between the top end and the bottom end of the body.

3. The clamping mechanism of claim 2, wherein the first and second ribs extend outward from the body, and wherein the first rib is oriented substantially parallel to the second rib.

4. The clamping mechanism of claim 2, wherein a separation gap is defined between the first rib and the second rib, wherein the separation gap extends from the top end to the bottom end of the body.

5. The clamping mechanism of claim 2, wherein a top fastener couples the first rib to the second rib near the top end of the body such that the top fastener is proximate the top portion of the body.

6. The clamping mechanism of claim 5, wherein a pivot mechanism rotatably couples the lever to the top fastener such that the lever is rotatable about the top portion of the body.

7. The clamping mechanism of claim 2, wherein the lever includes a cam, wherein the cam engages with the first rib of the body to move the first rib towards the second rib to cause the deformation when the lever is moved into the locked position.

8. The clamping mechanism of claim 2, wherein a distance between the first and second ribs decreases between the unlocked position to the locked position of the lever.

9. The clamping mechanism of claim 1, wherein during movement of the lever into the locked position, the lever flexes out of a normal configuration around the body for the lever, and wherein at or near the locked position, the lever flexes back towards the body to create an audible noise.

10. The clamping mechanism of claim 1, wherein in the locked position, an inner surface of the lever is at least partly engaged with the top portion of the body.

11. The clamping mechanism of claim 1, wherein in the locked position, the lever only partially surrounds the top portion of the body.

12. The clamping mechanism of claim 1, wherein the lever further includes a user interface member, the user interface member structured to enable a user to grip in order to move the lever between the locked and unlocked positions and vice versa.

13. The clamping mechanism of claim 1, wherein a cross-sectional shape of the top portion of the body substantially matches a cross-sectional shape of the lever.

14. A tree pruner, comprising:
an outer pole;
an inner pole disposed at least partly within the outer pole, the inner pole movable relative to the outer pole; and
a clamping mechanism coupled to the outer pole, the clamping mechanism structured to selectively engage with the inner pole to prevent relative movement between the inner and outer poles, wherein the clamping mechanism includes:
a body having a top portion, wherein the body is coupled to the outer pole; and
a lever movably coupled to the top portion between an unlocked position and a locked position, wherein the lever includes a cam surface that engages with the body during movement of the lever to the locked position to cause deformation of the top portion of the body to engage with the inner pole and prevent relative movement between the inner and outer poles in the locked position.

15. The tree pruner of claim 14, wherein the body includes a first rib and a second rib, wherein a separation gap is defined between the first rib and the second rib, wherein the separation gap is disposed in the top portion of the body.

16. The tree pruner of claim 15, wherein the cam surface engages with the first rib during movement to the locked position to move the first rib closer to the second rib to decrease the separation gap and cause the deformation of the top portion of the body.

17. The clamping mechanism of claim 1, wherein a cross-sectional shape of the inner pole substantially matches a cross-sectional shape of the top portion of the body, wherein the cross-sectional shape of inner pole and the cross-sectional shape of the top portion are substantially oval.

18. A tool, comprising
a pole;
a body at least partially surrounding the pole; and
a lever rotatably coupled to the body between a locked position and an unlocked position, the lever including a cam surface, wherein the cam surface engages with the body to deform the body in the locked position to substantially prevent relative movement between the pole and the body, and wherein a transition of the lever into the locked position creates an audible noise.

19. The tool of claim 18, wherein the body has a top end and a bottom end longitudinally opposite the top end, wherein the body defines a gap extending from the top end to the bottom end, wherein movement of the lever into the locked position decreases the gap in at least one position between the top end and the bottom end.

20. The tool of claim 18, wherein a cross-sectional shape of the pole matches a cross-sectional shape of the body.
